(19) United States
(12) Patent Application Publication
(10) Pub. No.: US 2014/0115701 A1
(43) Pub. Date: Apr. 24, 2014

(54) DEFENDING AGAINST CLICKJACKING ATTACKS

(71) Applicant: MICROSOFT CORPORATION, Redmond, WA (US)

(72) Inventors: Alexander Nikolaevich Moshchuk, Kirkland, WA (US); Jiahe H. Wang, Redmond, WA (US); Stuart Schechter, Kirkland, WA (US)

(73) Assignee: MICROSOFT CORPORATION, Redmond, WA (US)

(21) Appl. No.: 13/654,702

(22) Filed: Oct. 18, 2012

(51) Int. Cl. G06F 21/00

(52) U.S. Cl. 726/23

(57) ABSTRACT

Described is a technology directed towards protecting against clickjacking attacks against interactive user interface elements in code that are described by the code author as sensitive to clickjacking attacks. Various defenses are described, including defenses to ensure target display integrity, pointer integrity, and temporal integrity. For example, a browser click on an element/web page may be determined to be invalid if target display integrity is compromised. Also described are defenses that act to increase the user's attention to what is actually being clicked, and defenses that disable or disallow functions and features used by attackers, such as when a sensitive element is being hovered over.

### BACKGROUND

When multiple applications or web sites (or operating system principals in general) share a graphical display, they are subject to clickjacking attacks, (also known as UI redressing attacks). In a clickjacking attack, one principal tricks the user into interacting with (e.g., clicking, touching, or voice controlling) UI elements of another principal, triggering actions not intended by the user.

A typical clickjacking example is when a user is logged in to a victimized web site, visits the malicious site, and is tricked to interact on the victimized site, thinking he or she is interacting with the malicious site. For example, the attack may be based upon visual context, corresponding to what is seen by the user (e.g., a visible image that looks like one interactive element but overlays another, hidden interactive element), or temporal context, which does not give the user time to notice the actual visual context (e.g., by rapidly changing an interactive element).

In this way, clickjacking attackers may steal a user's private data by hijacking a button on the approval pages of the OAuth protocol, which lets users share private resources such as photos or contacts across web sites without handing out credentials. One frequent attack tricks the user into clicking on social media “Like” buttons or equivalent buttons. Other attacks have targeted webcam settings, allowing rogue sites to access the victim's webcam and spy on the user. Still other attacks have forged votes in online polls, committed click fraud, uploaded private files via the HTML5 File API, stole victims' location information, and injected content across domains by tricking the victim to perform a drag-and-drop action.

Existing clickjacking defenses have been proposed and deployed for web browsers, but have shortcomings. Today's most widely deployed defenses rely on framebusting, which disallows a sensitive page from being framed (i.e., embedded within another web page). However, framebusting is fundamentally incompatible with embeddable third-party widgets, such as social media “Like” buttons. Other existing defenses suffer from poor usability, incompatibility with existing web sites, or failure to defend against significant attack vectors.

### SUMMARY

This Summary is provided to introduce a selection of representative concepts in a simplified form that are further described below in the Detailed Description. This Summary is not intended to identify key features or essential features of the claimed subject matter, nor is it intended to be used in any way that would limit the scope of the claimed subject matter.

Briefly, various aspects of the subject matter described herein are directed towards a technology by which code such as an application is processed to detect an indication that one or more user interface elements are indicated in the code as a sensitive user interface element. One or more clickjacking defenses are employed with respect to each sensitive user interface element. In one aspect, employing a defense comprises comparing a reference bitmap representative of a sensitive element against an actual screenshot of a displayed representation of an area corresponding to that sensitive element, and allowing detected interaction to be returned to an element, or not, based upon whether comparing the bitmaps resulted in a match, or mismatch, respectively.

In various aspects, employing the one or more clickjacking defenses may comprise preventing transforms on at least one sensitive element, preventing transparency in the sensitive element, freezing at least part of a display screen, muting audio, overlaying a mask, and/or using at least one visual effect. The defenses may be employed when a pointer is in a region associated with a sensitive element.

In other aspects, cursor customization may be disabled when a pointer is in a region associated with a sensitive element, and/or when a sensitive element acquires keyboard focus, any change of keyboard focus by any other origin is disallowed.

In other aspects, interaction timing constraints when a pointer enters a sensitive region may be applied. This may include enforcing a click delay when a pointer enters a sensitive region of a sensitive element, or a sensitive region of a newly visible sensitive element, before a click is considered valid.

In one aspect, when a click occurs on a sensitive element and the sensitive element is not fully visible, and/or when a click occurs on the sensitive element before a delay time is met, the click is disallowed. When a pointer hovers over a sensitive element, at least one visible representation of a screen rendering is changed.

Other advantages may become apparent from the following detailed description when taken in conjunction with the drawings.

### BRIEF DESCRIPTION OF THE DRAWINGS

The present invention is illustrated by way of example and not limited in the accompanying figures in which like reference numerals indicate similar elements and in which:

FIG. 1 is a block diagram including components configured to protect against clickjacking, according to one example embodiment.

FIG. 2 is a block diagram of example components that compare an actual screenshot against a reference bitmap to evaluate whether spatial integrity is compromised, according to one example embodiment.

FIG. 3 is a flow diagram representing example steps that may be taken to evaluate whether spatial integrity is compromised, according to one example embodiment.

FIG. 4 is a flow diagram representing example steps that may be taken to defend against various clickjacking attacks, according to one example embodiment.

FIG. 5 is a block diagram representing an example computing environment, into which aspects of the subject matter described herein may be incorporated.

### DETAILED DESCRIPTION

Various aspects of the technology described herein are generally directed towards techniques and mechanisms that prevent and/or frustrate clickjacking attacks. In one aspect, any element that is sensitive with respect to clickjacking is identified, e.g., a web site application marks such an element as sensitive in its HTML (HyperText Markup Language) code or the like, and a browser recognizes each sensitive element. One or more protection mechanisms are applied to protect that sensitive element. For example, a bitmap corresponding to the sensitive element's displayed area is compared against a screenshot bitmap of the same area. If any difference exists, interaction with that element is not sent back. Visual highlighting, audio muting, keyboard protection and other mechanisms also may be used with respect to sensitive elements to prevent other types of spatial and/or temporal attacks.

As will be understood, the technology described herein is resilient to new attack vectors. At the same time, the technology described herein does not break existing web sites, but rather allows web sites to opt into protection from clickjacking. Clickjacking protection for third-party widgets (such as a social media “Like” button) is provided, in a way that is highly useable, e.g., the technology avoids prompting users for their actions.

It should be understood that any of the examples herein are non-limiting. For instance, some examples herein are described in the context of web browsers, such as implemented as an operating system component and/or a separate program; however, the concepts and techniques described are generally applicable to any client operating systems where a display is shared by mutually distrusting principals. Further, “clickjacking” as used herein refers to any way of tricking the user into interacting with a different element than intended even without any literal “click,” including keyboard stroke attacks (“strokejacking”) and pointer/cursor manipulation (“cursorjacking”). Still further, while Windows® and Internet Explorer concepts are used as examples, the technology may apply to virtually any operating system and/or browser code with sufficient capabilities. As such, the present invention is not limited to any particular embodiments, aspects, concepts, structures, functionalities or examples described herein. Rather, any of the embodiments, aspects, concepts, structures, functionalities or examples described herein are non-limiting, and the present invention may be used various ways that provide benefits and advantages in computers and preventing computer-related attacks in general.

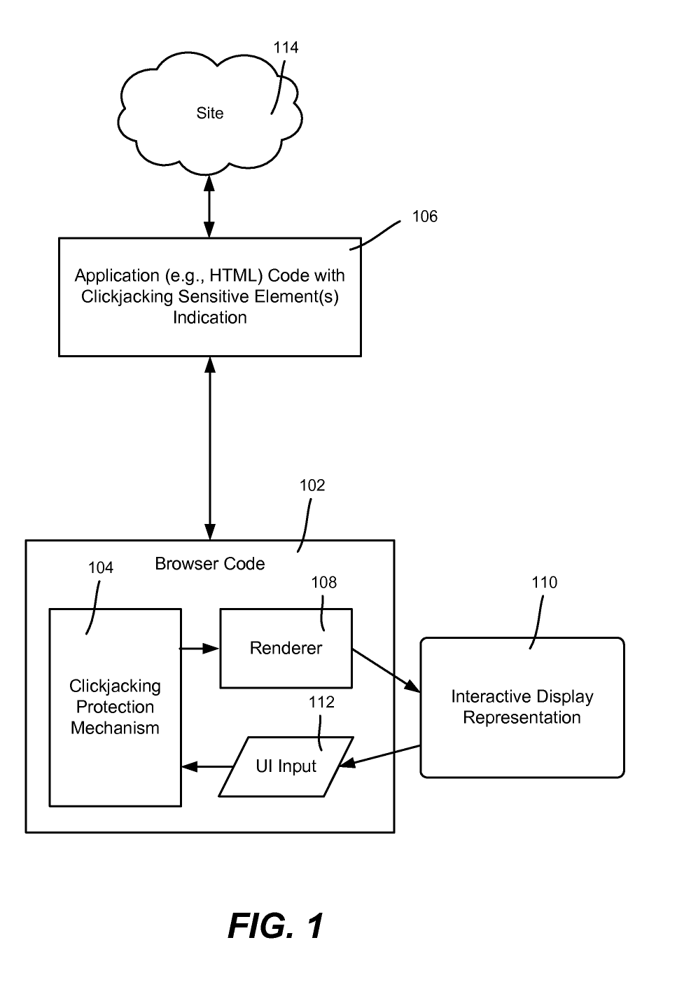

FIG. 1 shows a block diagram comprising an example implementation in which browser code 102 contains a clickjacking protection mechanism 104, which may be hardcoded with or incorporated into other browser code, a plug-in, or possibly a separate component with which other browser code communicates. In general, a web site/application author (developer) that wants to prevent clickjacking attacks provides HTML code 106 or the like, with an indication as to which elements are sensitive with respect to needing protection.

For example, an element (which may be one element or an entire page, for example) may be otherwise indicated as sensitive in a manner recognized by the browser code. This opt-in design has the author specify which element or elements are sensitive to the browser. In one implementation, a JavaScript API, and/or an HTTP response header may be used. The JavaScript APIs include the ability to detect client support for the defense, as well as handle raising of invalid click events raised when clickjacking is detected. The header approach is simpler as it does not require script modifications, and does not need to deal with attacks that disable scripting on the sensitive element.

As described herein, the protection mechanism 104 processes the HTML code and may determine what gets rendered and how by the renderer 108 to an interactive display representation 110. Further, when the user interacts with a sensitive element, the UI input 112 is obtained at the protection mechanism. Depending on what conditions are detected, the protection mechanism may return data (e.g., a click) representing the interaction to the code 106/web site 114, or may prevent the data from being returned, possibly instead returning information that an invalid click was detected.

Turning to attacks and defenses as described herein, a clickjacking attacker has the capabilities of a web attacker, including that they own a domain name and control content served from their web servers, and can often make a victim visit a site, thereby rendering attacker's content in the victim's browser. In one attack, when a victim user visits the attacker's page, the page hides a sensitive UI element either visually or temporally and lures the user into performing unintended UI actions on a sensitive element, out of context.

A clickjacking attacker exploits a system's inability to maintain context integrity for users' actions and thereby can manipulate the sensitive element visually or temporally to trick users. Existing attacks trick the user into issuing input commands out of context, including by compromising target display integrity, compromising pointer integrity, or compromising temporal integrity,

Attacks that compromise the target display integrity exploit the user-expected “guarantee” that users can fully see and recognize the target element before an input action. One such spatial attack effectively hides the target element. To this end, contemporary browsers support HTML/CSS (Cascading Style Sheet) styling features that allow attackers to visually hide a target element, but still route mouse events to it. For example, an attacker can make the target element transparent by wrapping it in a “div” container with a CSS opacity value of zero; to entice a victim to click on it, the attacker can draw a decoy under the target element by using a lower CSS z-index. Alternatively, the attacker may completely cover the target element with an opaque decoy, but make the decoy unclickable by setting the CSS property pointer-events:none; a victim's click falls through the decoy and lands on the (invisible) target element.

Partial overlays are another way to compromise target display integrity, in which it is sometimes possible to visually confuse a victim by obscuring only a part of the target element. For example, an attacker may overlay to cover the recipient and amount fields while leaving a “Pay” button intact; the victim thus has incorrect context when clicking on the “Pay” button. This overlaying can be done using CSS z-index or using well-known Flash® Player objects that are made topmost with the Window Mode property set to wmode=direct. Further, a target element may be partially overlaid by an attacker's popup window. Alternatively, the attacker may crop the target element to only show a piece of the target element, such as the “Pay” button, by wrapping the target element in a new iframe that uses carefully chosen negative CSS position offsets and the Pay button's width and height. An extreme variant of cropping is to create multiple 1×1 pixel containers of the target element and using single pixels to draw arbitrary clickable art.

With respect to compromising pointer integrity, users generally rely on cursor feedback to select locations for their input events. Proper visual context exists when the target element and the pointer feedback are fully visible and authentic. An attacker may violate pointer integrity by displaying a fake cursor icon away from the pointer, a subset of clickjacking referred as cursorjacking. This leads victims to misinterpret a click's target, because they will have the wrong perception about the current cursor location. Using the CSS cursor property, an attacker can hide the default cursor and programmatically draw a fake cursor elsewhere, or alternatively set a custom mouse cursor icon to a deceptive image that has a cursor icon shifted several pixels off the original position. An unintended element actually pointed to but not appearing as such then gets clicked, for example.

Another variant of cursor manipulation involves the blinking cursor that indicates keyboard focus (e.g., when typing text into an input field). Vulnerabilities in browsers allow attackers to manipulate keyboard focus using another subset of clickjacking referred to as strokejacking attacks. For example, an attacker can embed the target element in a hidden frame, while asking users to type some text into a fake attacker-controlled input field. As the victim is typing, the attacker can momentarily switch keyboard focus to the target element. The blinking cursor confuses victims into thinking that they are typing text into the displayed input field, whereas they are actually interacting with the target element.

Another type of clickjacking attack is directed towards compromising temporal integrity, in which the attack is based upon not giving users enough time to comprehend where they are clicking. To this end, instead of manipulating visual context to trick the user into sending input to the wrong UI element, an orthogonal way of tricking the user is to manipulate UI elements after the user has decided to click, but before the actual click occurs. Humans typically require a few hundred milliseconds to react to visual changes, and attackers can take advantage of such a slow reaction time to launch timing attacks. For example, an attacker may move the target element (via CSS position properties) on top of a decoy button shortly after the victim hovers the cursor over the decoy, in anticipation of the click. To predict clicks more effectively, the attacker may ask the victim to repetitively and/rapidly click moving objects in a malicious game, or to double-click on a decoy button, moving the target element over the decoy immediately after the first click. For example, this may be used to cause a link to the attacker's site to be reposted to the victim's friends, thus propagating the link virally.

Thus, to summarize the above attacks, an attacker application presents a sensitive UI element of a target application out of context to the user, and hence the user gets tricked to act out of context. Enforcing visual integrity ensures that the user is presented with what the user is supposed to see before an input action. Enforcing temporal integrity ensures that the user has enough time to comprehend with which UI element the user is interacting.

To ensure visual integrity at the time of a sensitive user action, the clickjacking protection mechanism 104 makes the display of the sensitive UI elements and the pointer feedback (such as cursors, touch feedback, or NUI input feedback) fully visible to the user. The clickjacking protection mechanism 104 only activates sensitive UI elements and delivers user input to them when both target display integrity and pointer integrity are satisfied.

Note that it is possible to enforce the display integrity of all the UI elements of an application, however such whole-application display integrity is often not necessary. For example, not all web pages of a web site contain sensitive operations and are susceptible to clickjacking. Thus, application authors may specify which UI elements or web pages are sensitive. To this end, sensitive content is protected with context integrity for user actions, so that the embedding page cannot clickjack the sensitive content.

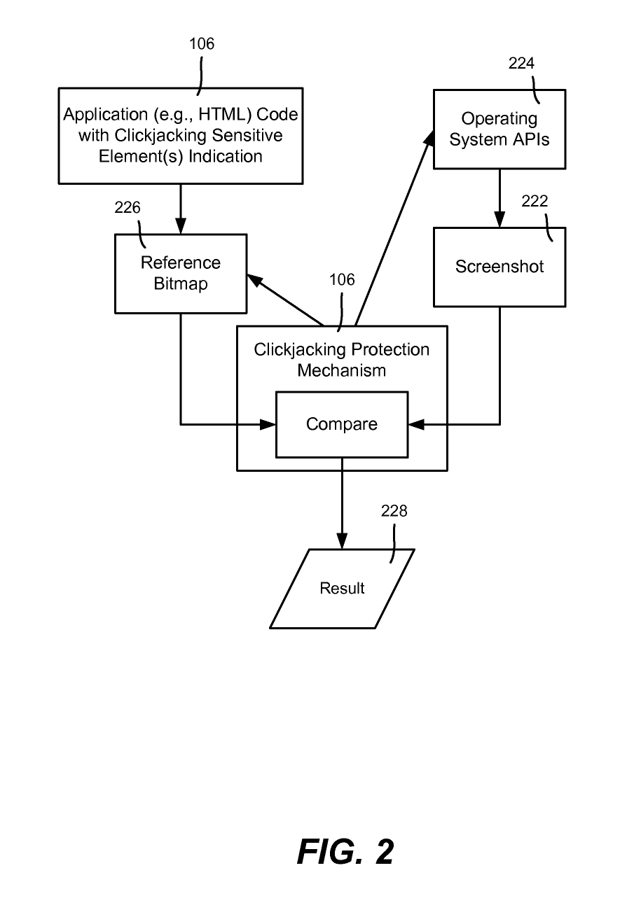

In one aspect generally represented in FIG. 2, the clickjacking protection mechanism 104 may enforce target display integrity by comparing the operating system-level screenshot 222 of the area that contains the sensitive element (what the user sees), and a bitmap 224 of the sensitive element rendered in isolation at the time of user action. If they are not the same, then the user action is canceled and not delivered to the sensitive element. An indication of an invalid click may be returned instead. Note that in one implementation, bitmap comparison functions are not directly exposed in JavaScript (and the bitmap comparison can only be triggered by user-initiated actions), otherwise they might be misused to probe pixels across origins using a transparent frame.

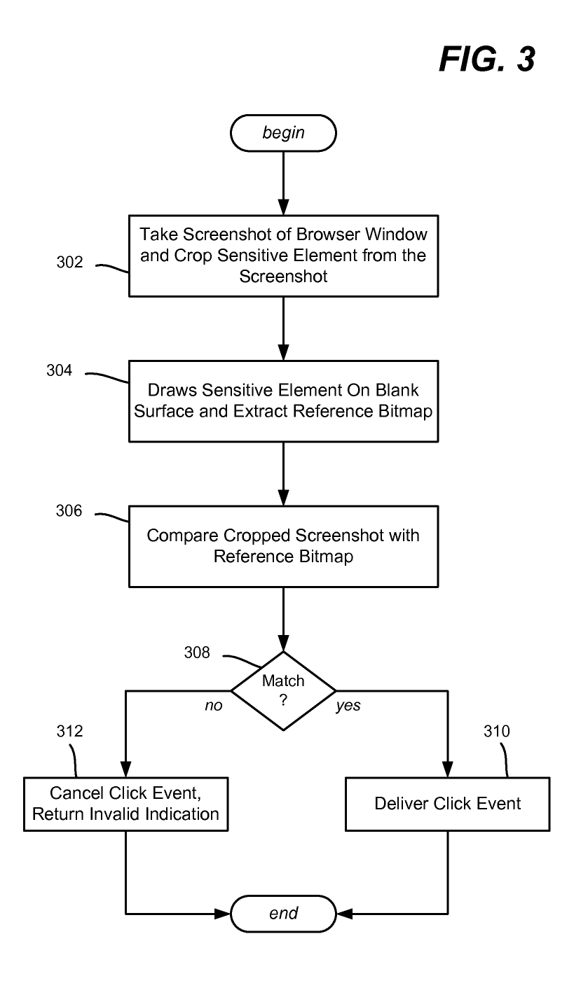

By way of example, the application author can opt-in to clickjacking protection by labeling an element such as a “Pay” button as sensitive in the corresponding HTTP response. Before delivering a click event to the “Pay” button, the protection mechanism 104 performs the steps generally represented in FIG. 3. As represented by step 302, the protection mechanism 104 determines what the user currently sees at the position of the “Pay” button on the screen by taking a screenshot of the browser window and cropping the sensitive element from the screenshot to provide a cropped screenshot 222 based on the element's position and dimensions known by the protection mechanism/browser code. To this end, operating system APIs 224 (e.g., the GDI BitBlt function in Windows®) are used in one implementation to take a screenshot of the browser window, rather than relying on the browser to generate screenshots, making it more robust to rendering performed by any plug-ins.

As represented by step 304, the protection mechanism 104 also determines what the sensitive element should look like if rendered in isolation and uses this as a reference bitmap 226 (FIG. 2). To this end, the browser draws the sensitive element on a blank surface and extracts its bitmap as the reference bitmap 226, e.g., using the Internet Explorer's IHTMLElementRender interface to generate the reference bitmap 226 in one implementation).

At steps 306 and 308, the protection mechanism compares the cropped screenshot 222 with the reference bitmap 226. A match corresponds to a valid click result 228 (FIG. 2) sent to the application that contains the sensitive element at step 310. A mismatch means that the user does not fully see the underlying button that the click is actually targeting. In this case, the protection mechanism detects a potential clickjacking offense and cancels the delivery of the click event. Instead, protection mechanism triggers a new invalid click (e.g., “oninvalidclick”) event as the result 228 to give the application an indication of the problem via step 312.

This design is resilient to new visual spoofing attack vectors because it uses only the position and dimension information from the browser layout engine to determine what the user sees. This is generally more reliable than using sophisticated logic (such as CSS) from the layout engine to determine what the user sees. By obtaining the reference bitmap at the time of the user action on a sensitive UI element, this design works well with dynamic UIs (such as animations or movies) in a sensitive UI element.

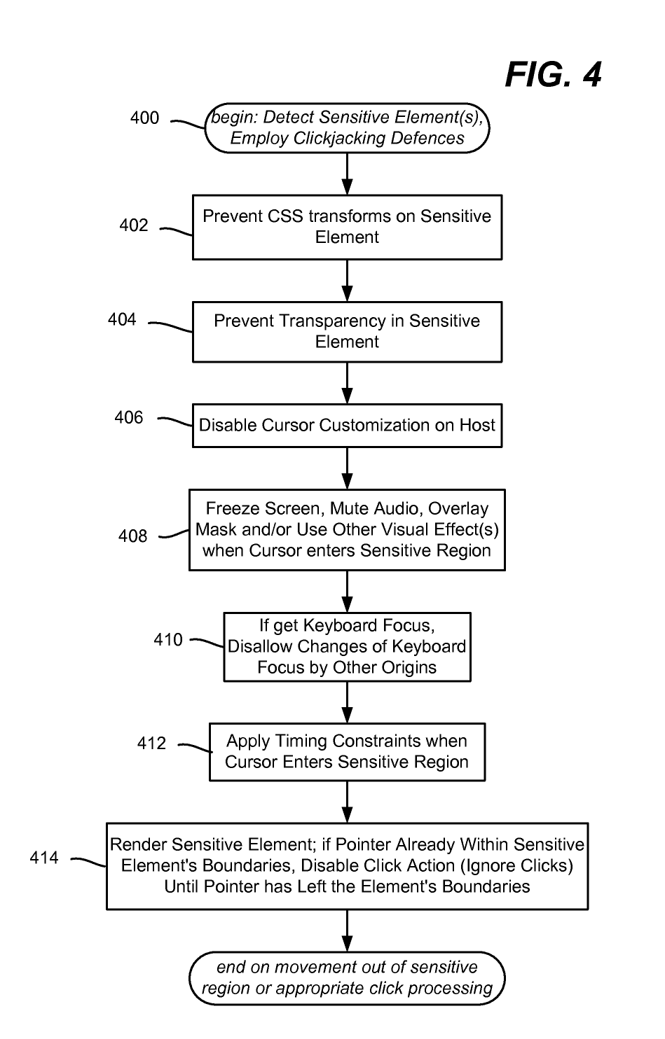

Note that as further protection, a host page can be prevented from applying any CSS transforms (such as zooming, rotating, and the like) that affect embedded sensitive elements; any such transformations are ignored by the browser code that has a clickjacking protection mechanism 104. This is generally represented in FIG. 4, step 402, and prevents malicious zooming attacks or the like, which change visual context via zoom. Any transparency inside the sensitive element itself also may be prevented (step 404), so that attackers cannot violate visual context by inserting decoys that show through the sensitive element.

Turning to guaranteeing pointer Integrity, the defenses described herein include one or more directed towards preventing an attacker from spoofing the real pointer. For example, an attack page may show a fake cursor to shift the user's attention from the real cursor and cause the user to act out of context by not looking at the destination of an action. To mitigate this, the protection mechanism ensures that users see system-provided (rather than attacker-simulated) cursors, so that the user is paying attention to the correct location before interacting with a sensitive element.

In one implementation, one or more various techniques described herein may be used, individually or in various combinations. As will be understood, some of the techniques limit the attackers' ability to carry out pointer-spoofing attacks, while others draw the user's attention to the correct place on the screen.

Current browsers disallow cross-origin cursor customization. This policy may be further restricted, in that when a sensitive element is present, the protection mechanism disables (step 406) cursor customization on the host (which embeds the sensitive element) and on all of the host's ancestors, so that a user always sees the system cursor in the surrounding areas of the sensitive element. This opt-in design allows a web site to customize the pointer for its own UIs (i.e., same-origin customization). For example, a text editor may want to show different cursors depending on whether the user is editing text or selecting a menu item.

Because humans typically pay more attention to animated objects than static ones, attackers may try to distract a user away from her actions with animations. To counter this, at step 408 the protection mechanism may “freeze” the screen (e.g., by ignoring rendering updates) around a sensitive UI element when the cursor enters the element, or approaches the element to within a certain “padding” area.

Sound may be used to draw a user's attention away from his or her actions. For example, a voice may instruct the user to perform certain tasks, and loud noise may trigger a user to quickly look for a way to stop the noise. To stop sound-based distractions, at step 408 the protection mechanism also may mute the speakers when a user interacts with sensitive elements.

Greyout (also called Lightbox) effects are commonly used for focusing the user's attention on a particular part of the screen (such as a popup dialog). In one implementation, this effect is used by overlaying (also step 408) a dark mask on rendered content around the sensitive UI element whenever the cursor is within that element's area. This causes the sensitive element to stand out visually. The mask generally cannot be a static one, otherwise an attacker can use the same static mask in its application to dilute the attention-drawing effect of the mask. Instead, a randomly generated mask comprising a random gray value at each pixel may be used.

As can be readily appreciated, various other techniques and mechanisms (e.g., including one or more other visual effects in step 408) may be used. For example, the user's attention may be focused by drawing with splash animation effects on the cursor or the element.

To stop strokejacking attacks that steal keyboard focus, once the sensitive UI element acquires keyboard focus (e.g., for typing text in an input field), programmatic changes of keyboard focus by other origins are disallowed. This is represented in FIG. 4, step 410.

Even with visual integrity, an attacker can take a user's action out of context by compromising the temporal integrity of a user's action, as described herein. For example, a timing attack may bait a user with a “claim free prize” button and then switch in a sensitive UI element (with visual integrity) at the expected time of user click.

To mitigate such race conditions on users, the protection may impose constraints (step 412) for a user action on a sensitive UI element. UI delay may be applied to only deliver user actions to the sensitive element if the visual context has been the same for a minimal time period. For example, in one bait-and-switch attack, the click on the sensitive UI element will not be delivered unless the sensitive element (together with the pointer integrity protection such as greyout mask around the sensitive element) has been fully visible and stationary for a sufficiently long time, which may be user and/or author configurable.

The UI delay technique may be vulnerable to an attack that combines pointer spoofing with rapid object clicking. Thus, the UI delay may be imposed each time the pointer enters the sensitive element (which may include a padding area around that sensitive element). Note that the plain UI delay may still be necessary, e.g., on touch devices which have no pointer.

As represented via step 414, pointer re-entry on a newly visible sensitive element may be protected against, in that when a sensitive UI element first appears or is moved to a location where it will overlap with the current location of the pointer, a clickjacking protection-capable browser invalidates input events until the user explicitly moves the pointer from the outside of the sensitive element to the inside. In other words, when a sensitive element is rendered, and the pointer is already within the sensitive element's boundaries, a click action is disabled (e.g., one or more clicks are ignored) until the pointer has left the element's boundaries. Relative to the UI delay technique, an advantage of the pointer re-entry technique is that a suitable delay need not be determined, (which may be difficult, e.g., for different users, different element sizes, etc.). Note that an alternate design of automatically moving the pointer outside the sensitive element may be misused by attackers to programmatically move the pointer. This defense applies to devices and operating systems that provide pointer feedback.

In one implementation, to implement the UI delays the UI delay is reset whenever the top-level window is focused, and whenever the computed position or size of the protected element has changed. These conditions are checked whenever the protected element is repainted, before the actual paint event, where paint events are detected using Internet Explorer binary behaviors with the IHTMLPainter::Draw API. The UI delay is also reset whenever the protected element becomes fully visible (e.g., when an element obscuring it moves away) by using the above-described visibility checking functions. When the user clicks on the protected element, the protection mechanism 104 checks the elapsed time since the last event that changed visual context. One implementation makes the granularity of sensitive elements to be HTML documents (this includes iframes); alternately, protection may be enabled for finer-grained elements such as DIVs.

As mentioned herein, the sensitive UI element's padding area (e.g., extra whitespace separating the host page from the embedded sensitive element) needs to be sufficiently thick so that a user is clear whether the pointer is on the sensitive element or on its embedding page. This further ensures that during rapid cursor movements, such as those that occur when a user is rapidly clicking moving objects, the pointer integrity defenses such as screen freezing are activated early enough. The padding may be enforced by the browser and/or implemented by the developer of the sensitive element.

### Example Operating Environment

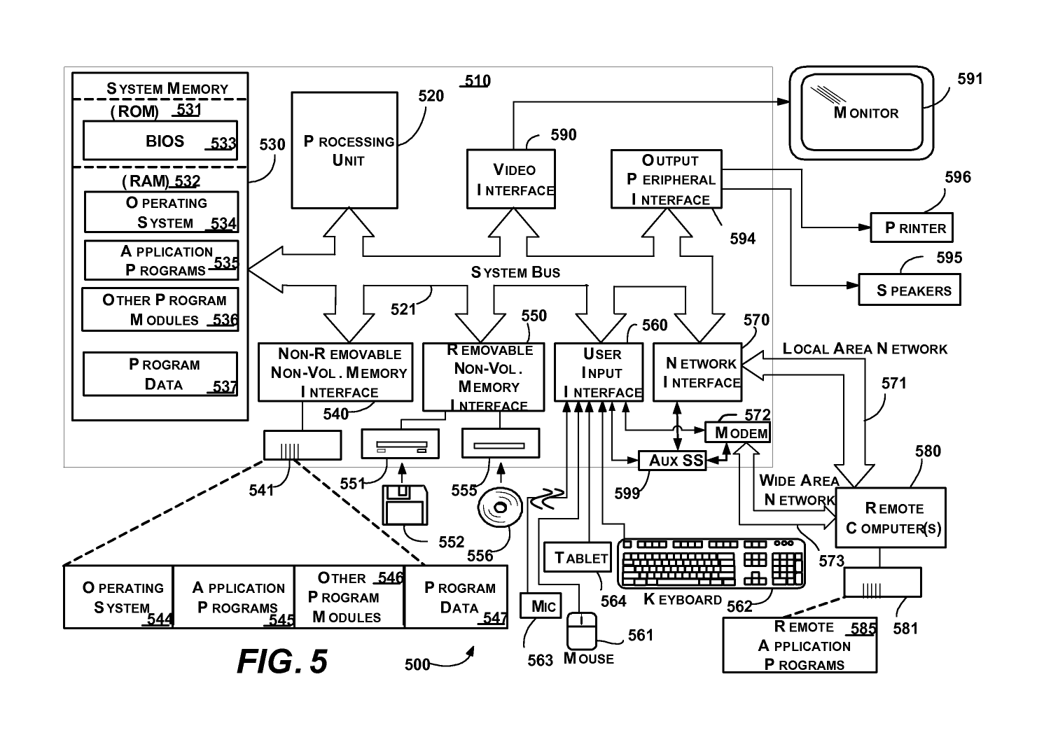

FIG. 5 illustrates an example of a suitable computing and networking environment 500 into which the examples and implementations of any of FIGS. 1-4 may be implemented, for example. The computing system environment 500 is only one example of a suitable computing environment and is not intended to suggest any limitation as to the scope of use or functionality of the invention. Neither should the computing environment 500 be interpreted as having any dependency or requirement relating to any one or combination of components illustrated in the example operating environment 500.

The invention is operational with numerous other general purpose or special purpose computing system environments or configurations. Examples of well-known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, and so forth, which perform particular tasks or implement particular abstract data types. The invention may also be practiced in distributed computing environments where tasks are performed by remote processing devices that are linked through a communications network. In a distributed computing environment, program modules may be located in local and/or remote computer storage media including memory storage devices.

With reference to FIG. 5, an example system for implementing various aspects of the invention may include a general purpose computing device in the form of a computer 510. Components of the computer 510 may include, but are not limited to, a processing unit 520, a system memory 530, and a system bus 521 that couples various system components including the system memory to the processing unit 520. The system bus 521 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 510 typically includes a variety of computer-readable media. Computer-readable media can be any available media that can be accessed by the computer 510 and includes both volatile and nonvolatile media, and removable and non-removable media. By way of example, and not limitation, computer-readable media may comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer 510. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above may also be included within the scope of computer-readable media.

The system memory 530 includes computer storage media in the form of volatile and/or nonvolatile memory such as read only memory (ROM) 531 and random access memory (RAM) 532. A basic input/output system 533 (BIOS), containing the basic routines that help to transfer information between elements within computer 510, such as during start-up, is typically stored in ROM 531. RAM 532 typically contains data and/or program modules that are immediately accessible to and/or presently being operated on by processing unit 520. By way of example, and not limitation, FIG. 5 illustrates operating system 534, application programs 535, other program modules 536 and program data 537.

The computer 510 may also include other removable/non-removable, volatile/nonvolatile computer storage media. By way of example only, FIG. 5 illustrates a hard disk drive 541 that reads from or writes to non-removable, nonvolatile magnetic media, a magnetic disk drive 551 that reads from or writes to a removable, nonvolatile magnetic disk 552, and an optical disk drive 555 that reads from or writes to a removable, nonvolatile optical disk 556 such as a CD ROM or other optical media. Other removable/non-removable, volatile/nonvolatile computer storage media that can be used in the example operating environment include, but are not limited to, magnetic tape cassettes, flash memory cards, digital versatile disks, digital video tape, solid state RAM, solid state ROM, and the like. The hard disk drive 541 is typically connected to the system bus 521 through a non-removable memory interface such as interface 540, and magnetic disk drive 551 and optical disk drive 555 are typically connected to the system bus 521 by a removable memory interface, such as interface 550.

The drives and their associated computer storage media, described above and illustrated in FIG. 5, provide storage of computer-readable instructions, data structures, program modules and other data for the computer 510. In FIG. 5, for example, hard disk drive 541 is illustrated as storing operating system 544, application programs 545, other program modules 546 and program data 547. Note that these components can either be the same as or different from operating system 534, application programs 535, other program modules 536, and program data 537. Operating system 544, application programs 545, other program modules 546, and program data 547 are given different numbers herein to illustrate that, at a minimum, they are different copies. A user may enter commands and information into the computer 510 through input devices such as a tablet, or electronic digitizer, 564, a microphone 563, a keyboard 562 and pointing device 561, commonly referred to as mouse, trackball or touch pad. Other input devices not shown in FIG. 5 may include a joystick, game pad, satellite dish, scanner, or the like. These and other input devices are often connected to the processing unit 520 through a user input interface 560 that is coupled to the system bus, but may be connected by other interface and bus structures, such as a parallel port, game port or a universal serial bus (USB). A monitor 591 or other type of display device is also connected to the system bus 521 via an interface, such as a video interface 590. The monitor 591 may also be integrated with a touch-screen panel or the like. Note that the monitor and/or touch screen panel can be physically coupled to a housing in which the computing device 510 is incorporated, such as in a tablet-type personal computer. In addition, computers such as the computing device 510 may also include other peripheral output devices such as speakers 595 and printer 596, which may be connected through an output peripheral interface 594 or the like.

The computer 510 may operate in a networked environment using logical connections to one or more remote computers, such as a remote computer 580. The remote computer 580 may be a personal computer, a server, a router, a network PC, a peer device or other common network node, and typically includes many or all of the elements described above relative to the computer 510, although only a memory storage device 581 has been illustrated in FIG. 5. The logical connections depicted in FIG. 5 include one or more local area networks (LAN) 571 and one or more wide area networks (WAN) 573, but may also include other networks. Such networking environments are commonplace in offices, enterprise-wide computer networks, intranets and the Internet.

When used in a LAN networking environment, the computer 510 is connected to the LAN 571 through a network interface or adapter 570. When used in a WAN networking environment, the computer 510 typically includes a modem 572 or other means for establishing communications over the WAN 573, such as the Internet. The modem 572, which may be internal or external, may be connected to the system bus 521 via the user input interface 560 or other appropriate mechanism. A wireless networking component 574 such as comprising an interface and antenna may be coupled through a suitable device such as an access point or peer computer to a WAN or LAN. In a networked environment, program modules depicted relative to the computer 510, or portions thereof, may be stored in the remote memory storage device. By way of example, and not limitation, FIG. 5 illustrates remote application programs 585 as residing on memory device 581. It may be appreciated that the network connections shown are examples and other means of establishing a communications link between the computers may be used.

An auxiliary subsystem 599 (e.g., for auxiliary display of content) may be connected via the user interface 560 to allow data such as program content, system status and event notifications to be provided to the user, even if the main portions of the computer system are in a low power state. The auxiliary subsystem 599 may be connected to the modem 572 and/or network interface 570 to allow communication between these systems while the main processing unit 520 is in a low power state.

### CONCLUSION

While the invention is susceptible to various modifications and alternative constructions, certain illustrated embodiments thereof are shown in the drawings and have been described above in detail. It should be understood, however, that there is no intention to limit the invention to the specific forms disclosed, but on the contrary, the intention is to cover all modifications, alternative constructions, and equivalents falling within the spirit and scope of the invention.

What is claimed is:

1. In a computing environment, a method comprising, processing code, including detecting an indication that at least one user interface element is indicated in the code as a sensitive user interface element, and employing one or more clickjacking defenses with respect to each sensitive user interface element.

2. The method of claim 1 wherein employing the one or more clickjacking defenses comprises comparing a reference bitmap representative of a sensitive element against an actual screenshot of a displayed representation of an area corresponding to that sensitive element, and allowing detected interaction to be returned to an element, or not, based upon whether comparing the bitmaps resulted in a match, or mismatch, respectively.

3. The method of claim 2 wherein a user-initiated action triggers the comparing of the bitmaps.

4. The method of claim 1 wherein employing the one or more clickjacking defenses comprises preventing transforms on at least one sensitive element.

5. The method of claim 1 wherein employing the one or more clickjacking defenses comprises preventing transparency in the sensitive element.

6. The method of claim 1 wherein employing the one or more clickjacking defenses comprises freezing at least part of a display screen or muting audio, or both, when a pointer is in a region associated with a sensitive element.

7. The method of claim 1 wherein employing the one or more clickjacking defenses comprises overlaying a random mask, or using at least one visual effect, or both, when a pointer is in a region associated with a sensitive element.

8. The method of claim 1 wherein employing the one or more clickjacking defenses comprises protecting against cursorjacking, including disabling cursor customization when a pointer is in a region associated with a sensitive element.

9. The method of claim 1 wherein employing the one or more clickjacking defenses comprises disallowing any change of keyboard focus by any other origin when a sensitive element acquires keyboard focus.

10. The method of claim 1 wherein employing the one or more clickjacking defenses comprises applying one or more interaction timing constraints when a pointer enters a sensitive region.

11. The method of claim 10 wherein applying the one or more interaction timing constraints comprises enforcing a click delay when a pointer enters a sensitive region of a sensitive element, the sensitive element comprising the sensitive element's area, or a padding region around the sensitive element's area, or both the sensitive element's area and a padding region around the sensitive element's area, before a click is considered valid.

12. The method of claim 1 wherein when a sensitive element is rendered, if the pointer is already within the sensitive element's boundaries, a click action is disabled until the pointer has left the element's boundaries.

13. A system comprising, at least one processor and memory, the memory including instructions, corresponding to a clickjacking protection mechanism, that are executed by the processor, the clickjacking protection mechanism configured to take preventative action with respect to a user interface element that is indicated as sensitive within code, including evaluating data of an actual screenshot against data rendered from the code to determine whether any difference exists.

14. The system of claim 13 wherein the data rendered from the code comprises a reference bitmap corresponding to a sensitive element.

15. The system of claim 13 wherein the clickjacking protection mechanism is incorporated into or otherwise associated with a browser.

16. The system of claim 13 wherein the code comprises a website application, and wherein the code contains information indicative of each sensitive element therein.

17. The system of claim 13 wherein the clickjacking protection mechanism includes one or more defenses corresponding to protecting target display integrity, pointer integrity, or temporal integrity, or any combination of target display integrity, pointer integrity, or temporal integrity.

18. The system of claim 13 wherein the clickjacking protection mechanism returns a data representing a valid interaction when no difference exists between data of the actual screenshot against data rendered from the code, or data representing an invalid interaction when any difference exists between data of the actual screenshot against data rendered from the code.

19. One or more computer-readable media having computer-executable instructions, which when executed perform steps, comprising, protecting an element or page marked as sensitive, including determining when a pointer interacts with a sensitive element, and disallowing a click when a click occurs on the sensitive element and the sensitive element is not fully visible, or disallowing a click when a click occurs on the sensitive element before a delay time is met, or both.

20. The one or more computer-readable media of claim 19 having further computer executable instructions comprising, or changing at least one visible representation of a screen rendering when a pointer is hovering over an area associated with a sensitive element.
